(19) United States
(12) Patent Application Publication
(10) Pub. No.: US 2007/0049197 A1
(43) Pub. Date: Mar. 1, 2007

(54) Control device for audio players

(76) Inventor: Andre Klein, Frankfurt (DE)

Correspondence Address: STEPHEN D. SCANLON, JONES DAY, 901 LAKESIDE AVENUE, CLEVELAND, OH, 44114, US

(21) Appl. No.: 11/216,242

(22) Filed: Aug. 31, 2005

(51) Int. Cl. H04M 1/00; H04B 7/00

(52) U.S. Cl. 455/41.2; 455/569.2

(57) ABSTRACT

This invention relates to accessories for audio players used for downloading, storing and playing of audio files, i.e. music or spoken word content. More specifically the invention relates to a control device for a digital audio player including an FM transmitter, a wireless receiver for receiving mobile phone status information and an optional charging device/power supply. The control device for the audio player comprises a wireless receiver for receiving status information from a mobile phone; an audio player interface electrically coupleable with the audio player; a control unit for controlling, via the audio player interface, the audio player based on the received status information; and a wireless transmitter for transmitting an audio signal received via the audio player interface from the audio player to an external audio system. The control device can control the operation of the audio player depending upon incoming or outgoing calls. The invention avoids that the driver must operate the audio player when a phone call is established in order to mute and/or pause the audio player and enhances safety during driving a vehicle.

### BACKGROUND

1. Field

This invention relates to accessories for audio players used for downloading, storing and playing of audio files, i.e. music or spoken word content. More specifically the invention relates to a control device for a digital audio player, including an FM transmitter, a wireless receiver for receiving mobile phone status information and an optional charging device/power supply.

2. Description of the Related Art

Since the mid-1950s the electronic industry has searched for ways to offer consumers portable audio players with compact size. It all started with portable transistor radios, but it wasn't until 1979 when the world saw its first personal and portable audio revolution with the introduction of first truly portable audio cassette player. In 1983 a syndicate formed by leading entertainment electronics manufacturers released the Compact Disc—this event is often seen as the ‘Big Bang’ of the digital audio revolution (previously audio content had to be stored analogue). Subsequently, portable Compact Disc players emerged. Caused by the limited bandwidth of the Internet in the mid-1990s, various audio compression formats were introduced, of which MP3 (correctly MPEG-1 layer 3) is probably the most popular one. MP3 encoded files are capable of being stored on a computer. In the next logical step in 1998, the world's first portable MP3 player was introduced. Many others followed, including Apple Computer, Inc. in 2001 with the iPod™.

When listening to a portable digital audio player in a vehicle such as a car or a boat, the use of headphones is not only an uncomfortable, but also dangerous option, and in many countries as a matter of fact against the law (for the person who steers the vehicle). Passengers may therefore prefer listening to the audio files through the vehicle's built-in speakers. To enable this, there are numerous options available on the market including cassette adapters, direct wiring or FM transmitters, which allow listening to the audio source through any standard FM radio.

Although all those options improve the comfort of the listening experience, there remains a problem with incoming phone calls on the passenger's mobile phones. Incoming phone calls may not be heard when listening to the digital audio player at high volume. If heard, the fact that the digital audio player has to be manually paused before the telephone conversation can take place and manually resumed afterwards not only is annoying, but can also become a serious safety risk when moving at higher speeds.

Thus, there is a general need for a safe operation of the digital audio player in the vehicle.

There is a further need for a simple operation of the digital audio player in the vehicle, in particular when operated simultaneously with the mobile phone.

There is a further need for an integration of the digital audio player and the mobile phone.

There is a particular need for wirelessly connecting the mobile phone and a vehicle's audio system, e.g. for playing a ring tone or for allowing hands-free conversation.

### SUMMARY

The present invention overcomes the problems noted above and satisfies the above mentioned needs. The present invention relates to a control device for audio players comprising a wireless transmitter and a wireless receiver. The control device interconnects with a portable audio player, such as the Apple iPod™, and controls the audio player based on information received from a wireless device, such as an indication of a ring tone transmitted from a mobile phone via the wireless receiver. The wireless receiver is preferably based on the Bluetooth standard to interface with Bluetooth enabled mobile phones. Thus, the control device may control the operation of the audio player (e.g. Pause & Resume or Volume Control) depending upon incoming or outgoing calls.

The control device may be further wirelessly paired with a selected mobile phone to respond selectively only to information received from the selected phone. The wireless transmitter may further transmit the sound received from the audio player and/or the voice of the other party on the mobile phone via an external sound system, e.g. via a car stereo through the vehicle's speakers, thus, allowing hands-free conversation.

The control device, when interconnected to the digital audio player, may control the digital audio player and/or process the audio signal coming from the digital audio player. The control device may transmit either the sound from the digital audio player or the called or calling conversational partner's voice received from the mobile phone to the car stereo and the vehicle's speakers. This allows for a control of the audio player and of the sound produced by the vehicle's speakers depending on the state of the mobile phone (idle, off-hook, busy). The invention avoids that the driver must operate the audio player when a phone call is established in order to mute and/or pause the audio player and enhances safety during driving.

### DETAILED DESCRIPTION

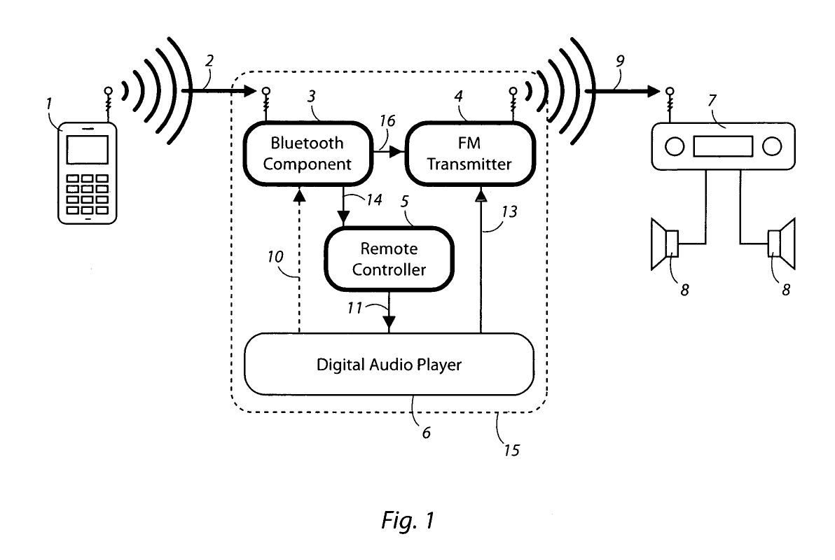

FIG. 1 is a schematic illustration of an embodiment of the invention and shows how individual components of the control device—integrated FM transmitter, Bluetooth chipset, remote control chipset, all interconnected with a digital audio player—interact which each other.

A Bluetooth-enabled phone 1 triggers the interaction process. A conventional radio receiver in an external audio system (e.g. a car stereo) 7 picks up the FM transmission broadcast from an integrated FM transmitter 4. The FM transmitter 4 transmits any audio signal 13 coming from the digital audio player 6 on an FM frequency, e.g. between 76 and 108 MHz, whereas the actual frequency used by the FM transmitter 4 for transmission may be user-adjustable or preset.

The broad frequency range covered by the FM transmitter 4 enables operation in a variety of countries. Standard FM receivers in the US for example operate at 87.9 to 107.9 MHz in steps of 0.2 MHz, Japanese FM receivers in contrast operate at 76.0 to 90.0 MHz in steps of 0.1 MHz. The FM transmitter might either offer the full band from 76.0 to 108.0 MHz or offer country-specific presets for frequency range and frequency steps.

The transmitted FM signal 9 can be received with any conventional FM radio 7 and then played through built-in or attached speakers 8. This allows convenient listening to the audio files stored on the audio player 6 without the need for wiring the audio player 6 to the external audio system 7.

Using a built-in Bluetooth component 3, the control device may be paired with a Bluetooth enabled phone 1. The pairing process may either be initiated using a button on the control device, or if the control device is integrated within the audio player, using the audio player's user interface. The mobile phone's unique identification signal is picked up by the Bluetooth component 3 of the control device during initialization and memorized for subsequent identification of the mobile phone 1.

The pairing method ensures that the control device only reacts to those mobile phones the user wants it to. This is mainly to avoid accidental control of the FM transmitter 4 or the digital audio player 6 to which the FM transmitter is connected to through other people's mobile phones which might be within operating range of the wireless receiver in the Bluetooth component 3.

If a paired phone located within the operating range of the invention rings on an incoming call or the user places an outgoing call, the Bluetooth signal 2 from this phone 1, as received by the Bluetooth component 3, causes a trigger signal 14 to be sent to a control unit (remote controller component) 5, which then will send a command 11 through an audio player interface to pause the playback of the digital audio player 6. The audio player interface may be configured to allow access to the audio player 6, send commands to the audio player 6, receive status information from the audio player 6, and receive the audio signal 13 from the audio player 6. The audio signal 13 may be an analog or digital signal and may be processed in the control unit 5 prior to transmission by the FM transmitter 4, e.g. to adjust the volume of the audio signal 13.

On incoming calls, the FM transmitter 4 sends a ring-tone to the FM receiver in the car stereo 7, notifying the user of the incoming call. When the user picks up the call (on outgoing calls: when the called party picks up the call), the conversational partner's voice gets routed (see arrow 16) from the Bluetooth component 3 to the FM transmitter 4 where it is transmitted, so it can be heard through the FM receiver in the car stereo 7, allowing hands-free conversation.

When the conversation ends (either party hangs up), the remote controller 5 receives, via the Bluetooth component 3, a respective signal from the mobile phone 1 and sends a command signal to the digital audio player 6 for resuming the playback.

If the digital audio player 6 to which the FM transmitter 4 is attached does not offer the option of being remote controlled from an external device, either wired or wirelessly, then the call-related actions may be limited to volume adjustment of the processed audio signal coming from the digital audio player 6 and/or switching between the FM transmitter's audio sources, namely the digital audio player 6 and the mobile phone 1. Instead of pausing and resuming the playback, the digital audio player 6 may keep playing during the conversation, but the audio signal gets muted (terminated) in the control device.

The Bluetooth component 3 may be also be used to transmit sound 10 from the digital audio player 6 or from the mobile phone 1 via Bluetooth to other Bluetooth-capable devices, such Bluetooth-enabled headphones or Bluetooth-enabled car radios.

Although the description is directed to an embodiment specifically making use of the Bluetooth standard for the communication between the mobile phone 1 and the control device, it will be recognized that the utility of the invention is not limited, but rather extends to and encompasses other wireless communications protocols used on mobile phones.

The control unit may comprise a programmable micro-controller and a memory unit for storing programs and data. The micro-controller may receive the trigger signal 14 indicating that a call is established at the mobile phone 1, control the processing of the FM transmitter 4 and generate respective control signals to control the audio player 6. The control of the audio player 6 may include the generation of analog or digital control signals which are communicated to the audio player 6 via the audio player interface, commonly a serial remote protocol, or by means of digital bus system interconnecting the audio player 6 and the control unit, e.g. a Firewire bus or USB.

The invention may be implemented as a separate control device attachable to the digital audio player 6 or integrated therewith. The integrated embodiment may comprise the digital audio player 6, the Bluetooth component 3, the remote controller 5 and the FM transmitter 4 arranged in one housing 15. The separate embodiment may comprise the Bluetooth component 3, the remote controller 5 and the FM transmitter 4 arranged in a control device housing attachable to the digital audio player 6 via docking means. The docking means may include a cable and/or a connector for electrically connecting to the digital audio player 6.

The shape/design of the control device housing may be designed such that it fits to the external shape of the digital audio player 6 and allows for a physical close attachment thereto. In one preferred embodiment of the invention, the control device housing is configured to take in and house the digital audio player 6 at least partially so that the combination of digital audio player 6 and control device form a compact unit which can be easily handled by the user and fitted to the interior of a vehicle, e.g. a dashboard cradle.

A power supply unit may be provided and included in the control device housing for supplying power to the control device components and/or the audio player. The power supply unit may be configured such that it charges the internal power supply, e.g. a battery, of the audio player 6. This allows for a recharging of the audio player 6 while listening to audio content played-back from the speakers 8 of the audio system 7. The electric power may be transmitted via the audio system interface through a cable and/or connector from the control device to the audio player 6.

Although the present invention is described by referring to preferred embodiments, it will be clear to a skilled person that it is not limited to the disclosed embodiments and modifications may be made without departing from the spirit and scope of the invention as set forth by the accompanying claims.

1. Control device for an audio player, comprising:
a wireless receiver for receiving status information from a mobile phone;
an audio player interface electrically coupleable with the audio player;
a control unit for controlling, via the audio player interface, the audio player based on the received status information; and
a wireless transmitter for transmitting an audio signal received via the audio player interface from the audio player to an external audio system.

2. Control device according to claim 1, wherein the status information indicates that an incoming or outgoing call is established and the control unit interrupts the transmission of the received audio signal to the external audio system.

3. Control device according to claim 2, wherein the control unit sends a command through the audio player interface to the audio player to stop, pause or resume the audio playback.

4. Control device according to claim 2, wherein the control unit mutes the audio signal received by the audio player interface from the audio player.

5. Control device according to claim 2, wherein the control unit processes the audio signal received by the audio player interface from the audio player for adjusting the volume of the audio signal.

6. Control device according to claim 2, wherein the control unit routes voice data received by the wireless receiver from the mobile phone to the wireless transmitter for transmission to the external audio system.

7. Control device according to claim 2, wherein the control unit sends an indication signal through the wireless transmitter to the external audio system for indicating that a call is received at the mobile phone.

8. Control device according to claim 2, wherein the wireless receiver is configured to communicate with the mobile phone by means of the Bluetooth protocol.

9. Control device according to claim 1, comprising a second wireless transmitter configured to communicate with at least one external device by means of the Bluetooth protocol.

10. Control device according to claim 1, wherein the wireless transmitter is adapted to transmit the audio signal to the external audio system in the FM band.

11. Control device according to claim 1, wherein the wireless receiver, the control unit and the wireless transmitter are arranged in a main body having docking means for attaching the audio player.

12. Control device according to claim 1, comprising a power supply unit for supplying electric power to the audio player.

13. Sound system including a control device according to claim 1 and a digital audio player connected to the audio player interface.
